(19) United States
(12) Patent Application Publication
(10) Pub. No.: US 2010/0191369 A1
(43) Pub. Date: Jul. 29, 2010

(54) SYSTEM OF MANAGEMENT, INFORMATION PROVIDING AND INFORMATION ACQUISITION FOR VENDING MACHINE BASED UPON WIRE AND WIRELESS COMMUNICATION AND A METHOD OF MANAGEMENT, INFORMATION PROVIDING AND INFORMATION ACQUISITION FOR VENDING MACHINE

(76) Inventor: Yeong-Ae Kim, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 12/513,271

(22) PCT Filed: Nov. 3, 2006
(86) PCT No.: PCT/KR2006/004580

§ 371 Date: Apr. 8, 2010

(51) Int. Cl. G06F 17/00; G06F 7/08; G06Q 50/00; G06Q 20/00; G06Q 30/00; G06K 9/00

(52) U.S. Cl. 700/235; 235/381; 700/237; 700/241; 382/181

(57) ABSTRACT

Disclosed is a system for managing a vending machine using wire and wireless two-way communication, and providing and acquiring various intangible knowledge information items, and a method of managing a vending machine, and providing and acquiring intangible knowledge information using the system.

### TECHNICAL FIELD

The present invention relates to a system for managing a vending machine using wire and wireless two-way communication, and providing and acquiring intangible knowledge information, such as product information, public service information and living information, using the vending machine, and to a method of managing a vending machine, and providing and acquiring intangible knowledge information using the system.

### BACKGROUND ART

In general, vending machines (automatic vending machines or self-service stands) provide users with tangible articles or intangible knowledge information when the users pay for the articles or the knowledge information. Such a vending machine can provide only the articles or the knowledge information supplied by an installer, but cannot immediately respond to articles or knowledge information that users want to acquire.

In order to solve this problem, Korean Patent Application No. 10-2003-0036792 (Registration No. 10-0503854) has been filed. However, according to this patent application, the vending machine can acquire only information and bonuses, such as coupons, provided by an information provider, but cannot meet demands of users who want to acquire information. In addition, the patent application has a problem in that it is difficult to manage the vending machine in real time.

Further, in order to effectively manage the vending machine and collected data, an administrator should check a variation in data in real time, analyze the data, and upload or download knowledge information. However, there are limitations in meeting the demands of users in real time even when the number of data administrators increases. In particular, when the number of vending machines or the amount of information increases, it is difficult to manage the vending machine or the information in real time.

Further, since a main server controls and manages these vending machines according to the related art, information and data are concentrated on one place. Therefore, when signals from the vending machines are concentrated, traffic is concentrated, and a data line or a server is overloaded, which makes it difficult to smoothly perform communication and control.

### DISCLOSURE

### Technical Problem

The invention is designed to solve the above-mentioned problems of the vending machine according to the related art, and an object of the invention is to provide a technique for analyzing articles or knowledge information used in a vending machine to provide articles or knowledge information that are frequently used, automatically analyzing/determining the arrangement/rearrangement of articles and knowledge information and the rearrangement of vending machines using an artificial intelligence algorithm, without the intervention of an administrator, to optimize the arrangement of articles, knowledge information, and vending machines, thereby providing articles and knowledge information necessary for vending machine users, giving a tangible or intangible reward to a user who purchases articles or knowledge information or reads the knowledge information, and enabling the user to use the reward to acquire a necessary article or knowledge information.

### Technical Solution

According to an aspect of the invention, in order to achieve the object, a system includes: a plurality of vending machines that provide articles or knowledge information; a plurality of local servers that group the vending machines and manage the groups of the vending machines; a main server that controls the local servers; and a wire and wireless communication network that connects the vending machines, the local servers, and the main server.

The system may further include: a mobile communication apparatus that can transmit or receive voice or data by wire or wirelessly; a human detection sensor that includes an optical sensor using an infrared ray or a laser beam, and a radio wave sensor, and can count the number of persons passing by the vending machine; or an image recognizing unit that can count the number of persons gathered in front of the vending machine for a predetermined time.

The vending machine has the same structure as that of a general vending machine (an automatic vending machine or a self-service stand) that is provided with a power supply, has articles loaded therein, and can discharge the articles to the outside. The vending machine may include: a cooling and heating device that cools or heats the articles loaded therein; a display device that visually displays the knowledge information or outputs it as a sound, and has an input unit, such as a touch screen, provided therein or an external input device added thereto; a selection input unit that selects the articles or the knowledge information; a payment unit that includes a slot into which a coin or paper money for articles is inserted, a reader that can read magnetic cards or IC cards, and an optical recognition unit that is used to pay for articles using the mobile communication apparatus or a mobile communication payment unit that communicates with an external communication unit to perform a payment process for articles; a discharge unit that discharges an article or a print out of the knowledge information; an external communication unit that is connected to the wire and wireless communication network; a memory device storing instructions, signal, and data that are input to or output from all the components of the vending machine or the outside; and a controller (CPU) that controls all the components of the vending machine.

The human detection sensor is a sensor that checks the number of persons passing by the vending machine according to date and time knowledge information, thereby collecting personal statistics, and uses the collected data to determine the kind of knowledge information and the time when the knowledge information is provided. For example, an optical sensor using an infrared ray or a laser beam or a radio wave sensor using radio waves may be used as the human direction sensor.

The image recognizing unit includes a camera that captures an image and image recognizing software that analyzes the captured image. When knowledge information is output from the display device, the image recognizing unit counts the number of persons who view the knowledge information for a predetermined time.

Each of the local servers and the main server is a general server, and includes a database (DB), a database management system DBMS, a hard disk, a storage unit, such as a RAM or a ROM; a CPU; and an I/O interface.

The local server and the main server store information on the vending machines and data for the knowledge information. A plurality of local servers are provided, and each local server is connected to a group of vending machines that are classified according to area or characteristics of articles or knowledge information provided, among the vending machines, by wire or wirelessly, to manage or control the group of vending machines. The local servers are connected to the main server by wire or wirelessly, and managed and controlled by the main server. In this way, it is possible to reduce the load of the main server and manage and control groups of vending machines according to characteristics of the groups. The main server may be connected to an external server that provides external specific knowledge information, thereby sharing information.

The wire and wireless communication network means a wire and wireless communication network, such as a telephone network, a local area network (LAN), a wide area network (WAN), a value added network (VAN), a dedicated line network, a power line communication (PLC) network, a satellite network, a wireless LAN, an commercial wireless communication network, or a personal wireless communication network, and includes the current commercial communication networks and wire and wireless communication networks that will be developed in the near future.

RFID tags, bar codes, color codes, or printed matters having numbers printed thereon that can be recognized by the mobile communication apparatus may be attached to the articles used in the vending machines.

Meanwhile, examples of the mobile communication apparatus include portable communication apparatuses, such as mobile phones, PDAs, PMPs (portable multimedia players), and computers that can communicate. For example, apparatuses that enable users to manually input numbers printed on articles and include a camera or an electronic reader (for example, an RFID reader) capable of electronically or optically recognizing RFID tags, bar codes or color codes may be used as the mobile communication apparatus.

Next, a method of providing intangible knowledge information, a method of acquiring intangible knowledge information, and a method of managing a vending machine using the system will be described.

The method of managing the vending machine manages articles that are load in or discharged from the vending machine and knowledge information that is stored in the vending machine or transmitted from the server and then output through the display device to determine the utility of the vending machine. That is, the method manages the sales of articles and knowledge information, stocks, and the determination of suitable information.

In the method of providing intangible knowledge information, the knowledge information means commercial or public text or multimedia information that is provided by an information provider in order to advertise or publicize his or her articles or businesses, and is provided to all the vending machine users regardless of the will of the users. The method of providing intangible knowledge information gives a reward to a person who reads the information.

In the method of acquiring intangible knowledge information, a person who wants to acquire information (referred to as an information acquirer in the invention) pays for desired information to acquire the information.

First, the method of managing a vending machine includes: a data collecting step of allowing each local server to collect data stored in the memories of the vending machines that are managed by the local server, the data including data for the positions of the vending machines, article information data, such as the kind and number of articles loaded in or discharged from the vending machines, date and time when the articles are loaded in or discharged from the vending machines, and knowledge information data, such as the kind of knowledge information items stored in or output from the vending machines, the number of hits of the knowledge information, and date and time when the knowledge information items are stored in or output from the vending machines; a data transmitting step of allowing the local server to transmit the collected data to the main server; a data classifying step of allowing the main server to classify the received data according to area, kind, date, time, the number of articles, and the number of hits of knowledge information; a data analyzing step of allowing the main server to analyze the classified data; a rearrangement determining step of allowing the main server to determine articles and knowledge information to be added or removed, that is, articles and knowledge information to be rearranged, on the basis of the analyzed data, using a determining algorithm; a similar article and knowledge information determining step of allowing the main server to determine articles and knowledge information to be added and similar articles and knowledge information, using an index table; a rearrangement executing step of allowing the main server to add or delete data that the main server will execute, among the data to be added or deleted and a rearrangement data transmitting step of allowing the main server to transmit data including rearrangement commands to each of the local servers; a rearranging step of allowing each of the local servers having received the rearrangement commands to add or remove articles or knowledge information according to the instructions from the main server; and a data updating step of allowing the main server and the local servers to update data on the basis of the executed data.

In addition, the rearrangement determining step, the similar article and knowledge information determining step, the rearrangement executing step and the rearrangement data transmitting step, and the rearranging step may further include a vending machine adding or removing step of adding or removing vending machines in a specific area.

In the data analyzing step, the utilization of each kind of article, the frequency of use thereof, a variation in the utilization, and the moving average of the utilization are analyzed.

The preference of each kind of article in each vending machine, a variation in the preference, and the moving average of the preference are analyzed.

The utilization of each vending machine, the frequency of use thereof, a variation in the utilization, and the moving average of the utilization are analyzed.

In the analysis of data, the utilization of a specific article can be analyzed by math figure 1 given below:

the utilization of Pi(%)={the number of uses of Pi÷Σ(the number of uses of Pn)}×100 [Math Figure 1]

(where ‘Pi’ indicates an i-th product, and ‘Σ(Pn)’ indicates the total number of products loaded in a specific vending machine).

The frequency of use of each kind of article is calculated by math figure 2 given below:

the frequency of use of Pi(%)=(the number of uses of Pi at Tn÷the total number of uses of Pi until Tn)×100 [Math Figure 2]

(where ‘Pi’ indicates an i-th product, and ‘Tn’ indicates n o′clock).

The variation in the utilization of each kind of article is calculated by math FIG. 3 given below:

variation in the utilization of Pi(%)={(the number of uses of Pi today−the number of uses of Pi on the previous day)÷the total number of uses of Pi per unit time}×100 [Math Figure 3]

The moving average of the utilization of each kind of article is calculated by math figure 4 given below:

the moving average of the utilization of Pi(%)={(the number of uses of Pi from N o′clock to M o′clock)÷(Tn+m−Tn)}×100 [Math Figure 4]

(where ‘Tn+m’ indicates n+m o′clock, and ‘Tn’ indicates n o′clock).

The preference of each kind of article in each vending machine is calculated by math figure 5 given below:

the preference of P(%)=[Σ(the number of uses of Pn)÷{Σ(the number of uses of Pn)+Σ(the number of uses of Rn)+σ(the number of uses of Mn)+Σ(the number of uses of In)}]×100 [Math Figure 5]

(where P indicates all the articles loaded in the vending machine, n=1, 2, 3, . . . , m, and R, M, and I indicate knowledge information or articles other than ‘P’).

A variation in the preference of each kind of article in each vending machine is calculated by math figure 6 given below:

variation in the preference of P(%)={(the preference of P today−the preference of P on the previous day)÷the total number of uses of P per unit time}×100 [Math Figure 6]

The moving average of the preference of each kind of article in each vending machine is calculated by math figure 7 given below:

the moving average of the preference of P(%)={(the preference of P from N o′clock to M o′clock)÷(Tn+m−Tn)}×100 [Math Figure 7]

The utilization of each vending machine is calculated by math figure 8 given below:

the utilization of a vending machine ‘a’(%)=(the number of persons using the vending machine ‘a’ per day÷the average number of persons using the vending machines belonging to a group ‘A’)×100 [Math Figure 8]

(where the average number of persons using the vending machines belonging to a group ‘A’=the total number of persons using the vending machines belonging to the group ‘A’÷the total number of vending machines belonging to the group ‘A’, and the vending machine ‘a’ is one of the vending machines belonging to the group ‘A’).

The frequency of use of each vending machine is calculated by math figure 9 given below:

the frequency of use of the vending machine ‘a’(%)=(the number of persons using the vending machine ‘a’ at Tn÷the total number of persons using the vending machined ‘a’ until Tn)×100. [Math Figure 9]

A variation in the utilization of each vending machine is calculated by math FIG. 10 given below:

variation in the utilization of the vending machine ‘a’={(the number of persons using the vending machine ‘a’ on a specific day−the number of persons using the vending machine ‘a’ the day before)÷the total number of persons using the vending machine ‘a’ per unit time}×100 [Math Figure 10]

The moving average of the utilization of each vending machine is calculated by math figure 11 given below:

the moving average of the utilization of the vending machine ‘a’(%)={(the number of persons using the vending machine ‘a’ from N o′clock to M o′clock)÷(Tn+m−Tn)}×100 [Math Figure 11]

In the rearrangement determining step, a fuzzy function is used as determining function used for a determining algorithm that determines to add or remove articles and knowledge information. That is, the fuzzy function is applied using the utilization, the frequency of use, and the variation in the utilization as input variables, and it is determined whether to add or remove articles and knowledge information on the basis of the result value.

In this case, a triangle or discrete variable is used in a membership function.

The triangle variable is represented by math figure 12 given below:

A(x)=1/{a(|x_{-b}|+a)}, a>0 [Math Figure 12]

(where ‘a’ indicates a fuzzy number, and ‘b’ indicates the value of x where the grade of the membership function is 1).

In math figure 12, the utilization is applied to an input value ‘x1’, the frequency of use is applied to an input value ‘x2’, and the variation in the utilization is applied to an input value ‘x3’.

A fuzzy rule is defined by math figure 13 given below:

If x₁ is Aᵢ₁, x₂ is Aᵢ₂, x₃ is Aᵢ₃ then y is Bᵢ [Math Figure 13]

A fuzzy rule number is calculated by math figure 14 given below:

R=Uᵢ₌₁ⁿXRᵢ [Math Figure 14]

The fuzzy rule represented by math figure 13 is applied to all input values to obtain output values.

An output function is obtained by math figure 15 given below:

B^{o}=Uᵢ₌₁ⁿBᵢ^{x} [Math Figure 15]

In this case, Bᵢ^{x} is calculated by math figure 16 given below:

Bᵢ^{x}(y)=wᵢΛBᵢ(y) [Math Figure 16]

(where wᵢ indicates a cutting level).

In math figure 16, n inference results are the sum of inference results.

The results are calculated by the center of gravity.

The rearrangement of articles and knowledge information is determined in consideration of the calculated result values and the average value of the utilization.

The fuzzy function can be easily used with reference to the following documents. (1. L. A. Zadeh “Fuzzy Algorithms, Information and Control”, Vol. 12, 94/102 (1968), 2. E. H. Mandani, “Application of fuzzy algorithm for control for simple dynamic plant”, Proc, IEEE, Vol. 12, No. 12, 1585/1588 (1974), 3. M. Park, et al., “Fuzzy control system”, Daeyoungsa (1990), and 4. S. Chae, et al., “Fuzzy theory and control”, Cheong Moon Book Co. (1995)).

Meanwhile, the rearrangement of the vending machines, such as the addition or removal of the vending machines, is performed using the same fuzzy function as that used in the rearrangement of the articles or the knowledge information.

In this case, as input values of the fuzzy function represented by math figure 12, ‘x1’ indicates the utilization of each vending machine, ‘x2’ indicates the frequency of use of each vending machine, and ‘x3’ indicates a variation in the utilization of each vending machine.

A triangle function or a discrete fuzzy variable is used as the fuzzy function, and the center of gravity is used to calculate the results of the function.

In the similar article and knowledge information determining step, in order to select similar article or knowledge information, the articles or the knowledge information items may be classified and indexed, and the indexed data may be used to calculate similarity.

That is, the articles or the knowledge information items are classified according to attributes, such as sex (a male or a female), age (an old-old age, a young-old age, a middle age, a young age, a children, and a baby), the degree of harmfulness to health, taste (salty, sweet, hot, and sour), and the purpose of advertisement (a public advertisement or a commercial advertisement), product type (food or industrial products), and index numbers are assigned to the fields corresponding to the attribute. In addition, points indicating the level of each of the attributes may be written in each field, thereby establishing a database.

The articles may be classified according to the attributes as follows:

“Ca(article index, sex, age, the degree of health, taste, purpose, and product type)”.

This indicates the attributes of an ‘a’-th article in product ‘C’ written in the fields, which can be represented by the following numbers in the database:

“C5(1-5, 1, 4, 6, 2, 2, 1)”.

Specifically, ‘C5’ indicates a fifth article in the product ‘C’, ‘1-5’ indicates the index of the article, ‘1’ in the sex field indicates a male, ‘4’ in the age field indicates a children, ‘6’ in the health degree field indicates ‘good for health’, ‘2’ in the taste field indicates ‘sweet’, ‘2’ in the purpose field indicates ‘commercial advertisement’ and ‘1’ in the product type field indicates ‘food’.

These fields and attributes may be further classified in more detail.

The similarity is calculated on the basis of the database by math figure 17 given below:

$${C}_{a - b} = \sqrt{\begin{matrix}{( {x}_{a 1} - {x}_{b 1} )}^{2} + {( {x}_{a 2} - {x}_{b 2} )}^{2} + \\ {( {x}_{a 3} - {x}_{b 3} )}^{2} + … + {( {x}_{an } - {x}_{bn} )}^{2}\end{matrix}} \qquad [ Math Figure 17 ]$$

(where ‘C_{a-b}’ indicates the similarity between an a-th article and a b-th article in the product C in the highest category, ‘Xa1’ indicates the value of a first item of the a-th article in the product C, and ‘Xb1’ indicates the value of a first item of the b-th article in the product C). As the result of the calculation, it is determined that the smaller the calculated value is, the higher the similarity becomes, and the larger the calculated value is, the lower the similarity becomes.

In the above-mentioned math figures, only the article, that is, an i-th article ‘Pi’ is represented by numerical values. However, each kind of knowledge information, such as questions or advertisements other than the articles provided by the vending machine, may be represented by numerical values. For example, an i-th advertisement may be represented by ‘Mi’.

Next, the method of providing intangible knowledge information will be described.

The method includes: a basic data collecting step of allowing the main server to collect data for intangible knowledge information stored in the memories of the main server, the external server, each local server, and each vending machine; a scheduling step of allowing the main server to schedule the basic data and to allocate the kind of data to be executed by each vending machine, the time when the vending machine executes the basic data, and the number of times the vending machine executes the basic data, according to the schedule; a first data or command transmitting step of allowing the main server to transmit, to each local server, data for knowledge information that is allocated to each of the vending machines according to the schedule such that it is displayed on the display device of each of the vending machines, among the data stored in the main sever, allowing the main server to transmit, to each local server, commands to transmit data stored in the local server to each vending machine, or allowing the main server to transmit, to each local server, commands to execute data stored in each vending machine; a second command and data transmitting step of allowing each local server having received the data or commands to transmit, to the vending machines that are managed by the local server, data received from the main server, data stored therein, or commands to execute data stored in the vending machines; a data or command executing step of allowing each vending machine having received the data or command in the second data and command transmitting step to execute the received data or perform the received command on knowledge information data stored therein; an information displaying/outputting step of allowing the display device of each vending machine to visually display the knowledge information or output it as a sound according to the received data or commands; a result data collecting step of allowing the main server to collect the result data of the displayed information in real time or at predetermined time intervals; a data classifying step of allowing the main server to classify the collected result data, according to area, kind, date, time, the number of articles, and the number of hits; a data analyzing step of allowing the main server to analyze the classified data; and a result arranging step of allowing the main server to change the schedule according to the analyzed data, reselect data to be executed among the basic data according the changed schedule, and arrange the data.

The method may further include a traffic calculating step of allowing each vending machine to count the number of persons passing by the vending machine, using the human detection sensor, after the information displaying/outputting step. In this case, it is possible to use the number of persons passing by the vending machine for each date and time as data added to the result data obtained in the result data collecting step, thereby selecting the kind of schedule and data.

The method may further include an information recognition state checking step of allowing each vending machine to count the number of persons who view information displayed, using an image recognizing unit thereof, after the information displaying/outputting step. In this case, it is checked whether the persons actually recognize the information and how much the persons recognize the information on the basis of the number of persons who view the information displayed on the vending machine, and the utility of the information is verified on the basis of the check result. Then, data for the utility is used as data added to the result data obtained in the result data collecting step. In this way, it is possible to select the kind of schedule and data.

The basic data collecting step collects data that is stored in the memories of the main server, the external server, each local server, and each vending machine, and is scheduled to be executed. For example, the basic data collecting step collects knowledge information data scheduled to be executed, such as commercial or public service ads, weather information, product information, and official announcement of a village or a local community in which the vending machines are installed, which will be displayed on the vending machines.

The scheduling step schedules the knowledge information that will be executed and displayed on each vending machine. Specifically, the scheduling step schedules knowledge information to be displayed on the vending machines according to area and time, and changes or adds the schedule.

The first and second data or command transmitting steps transmit data to each vending machine such that data stored in the main server, the external server or each local server can be executed in the vending machine in a streaming method, or transmit commands such that data stored in the vending machines can be directly executed.

The information displaying/outputting step controls the display device to display or output the transmitted data or data executed by the transmitted commands as an image (for example, a picture or a moving picture) or a sound (audio) such that persons who pass by each vending machine view or listen to the image or the sound.

The result data collecting step collects the results of the data displayed or output by each vending machine, such as the position of the vending machine, the kind (for example, title or content) of data executed, date and time when the data is executed, the number of times the data is executed, the number of persons passing by the vending machine, and the number of persons who view the data executed.

The data analyzing step analyzes the collected and classified results under the conditions stored in the main server to find the most effective way to utilize the vending machines on the basis of date and time, the kind of data, and the installation position of the vending machine. The conditions stored in the main server are set by each vending machine operator or each data provider, and include data related to the position of a vending machine, that is, a shopping mall area, an office area, a residential area, a school area, a public office area, and a business area, data related to persons who pass by the vending machine, data related to a natural environment, such as date, time, and weather, and data related to a social environment, such as issues, economics, or the international situation.

The result arranging step reselects data to be executed on the basis of the analyzed data related to the effective utility of the vending machine according to the date and time, the kind of data, and the installation position of the vending machine, and controls the main server to change the schedule.

The traffic calculating step counts the number of persons who pass by each vending machine for each date and time, using the human detection sensor, such as an optical sensor or a radio wave sensor.

The information recognition state checking step counts the number of persons who view data displayed on each vending machine for a predetermined time, using an image capturing device, such as a camera, and an image recognizing software that analyzes the image captured by the image capturing device, thereby checking the degree of the recognition of the executed data.

Next, the method of acquiring knowledge information will be described.

The method of acquiring knowledge information includes a one-way information acquiring method that enables information acquirers to acquire desired knowledge information from each vending machine, a two-way information acquiring method that enables information acquirers to make a reservation (for example, a hotel, a restaurant, or a travel) or an order (for example, goods or books), and a method that enables an information provider to give a reward for the reading of knowledge information to vending machine users. The method of acquiring knowledge information is not a passive information acquiring method that passively acquires knowledge information executed, but an active information acquiring method that enables an information acquirer to actively acquire desired knowledge information.

The method of acquiring knowledge information includes: a menu display step of displaying a menu of the knowledge information to be provided to a display device provided in each vending machine; a knowledge information selecting step of selecting or inputting required knowledge information from the menu using a touch screen of the display device or an external input device provided in the vending machine; a location checking step of allowing the main server to check the position of the selected or input knowledge information; a payment request step of requesting payment for providing the checked knowledge information; a payment step of paying for articles or knowledge information by selecting at least one of cash payment, the reading of knowledge information provided by the vending machine, and the use of points saved; a knowledge information displaying/outputting step of displaying or outputting the knowledge information paid for by money by at least one of a method of displaying the knowledge information on the display device of each vending machine, a method of providing the knowledge information as a print out, and a method of transmitting the knowledge information to a mobile communication apparatus of a person who acquires the knowledge information; a result data collecting step of allowing the main server to collect the result data of the displayed knowledge information and data for the paid point in real time and at a predetermined time interval; a data classifying step of allowing the main server to classify the collected result data according to area, kind, date, time, the number of articles, and the number of hits; a data analyzing step of allowing the main server to analyze the classified data; and a result arranging step of allowing the main server to determine whether to add or delete knowledge information data on the basis of the analyzed data, and reflect the knowledge information.

The menu display step displays a menu, such as an icon-shaped menu or a menu capable of inputting a file name, that enables a user to select or search knowledge information to be provided to the display device of each vending machine including a monitor and a speaker. In the knowledge information selecting step, in an initial screen of the display device, the menu can be selected by touching the touch screen or manually inputting a file name.

The knowledge information selecting step selects the menu by touching the touch screen, using an input device, such as a mouse or a keyboard, or manually inputting a file name using the touch screen or the input device, thereby reading knowledge information.

The location checking step checks the location of the selected knowledge information data. Specifically, the location checking step checks the location of the selected knowledge information data in the memories of the main server, the external server, each local server, and each vending machine to issue appropriate commands.

The payment request step requests payment for the selected knowledge information.

The payment step pays for goods or knowledge information by using cash, such as coins, paper money, a credit card, or a bus card, or using points saved in a mobile communication apparatus, which are a substitute for money. The following methods can be used to pay for goods or knowledge information: a method of inserting coins or paper money into a slot of each vending machine; a method of inserting the credit card or the bus card into a magnetic or electronic card reader; a method of paying money for goods with points saved in the mobile communication apparatus by displaying a mark corresponding to the saved points, such as a bar code, on a liquid crystal display device of the mobile communication apparatus and controlling the mobile communication payment unit to recognize the mark, or by wireless communication with the mobile communication service provider who manages the mobile communication apparatus; and a method of giving a reward to a user who reads or views knowledge information, for example, a user who views a specific ad or answers questionnaires.

Various methods can be used to save points in the mobile communication apparatus. However, in the invention, points can be saved by using RFID tags, bar codes, color codes, or numbers printed on the articles that are purchased by consumers through the vending machine, or by answering questionnaires given by each vending machine or viewing advertisement. The reward for the answering of the questionnaires or the viewing of the advertisement may be displayed as bar codes or color codes on the display device of the vending machine. Therefore, the user may photograph the bar codes or the color codes using a camera of the mobile communication apparatus to store them, and use the bar codes or the color codes, if necessary. Alternatively, the codes may be decoded and the decoded data may be transmitted to the mobile communication service provider to save points. When numbers are displayed, the user may save the points by inputting the numbers during a phone call on the mobile communication service provider. When the user has a mobile communication apparatus with an RF recognizing function, the user can save points by receiving signals transmitted from the mobile communication payment unit of the vending machine. That is, the points may be directly stored in the mobile communication apparatus, or they may be stored as data in the server of the mobile communication service provider.

The knowledge information displaying/outputting step displays and outputs knowledge information that an information acquirer wants to acquire on the display device of the vending machine as an image and a sound, or transmits data to the mobile communication apparatus of the information acquirer such that the information acquirer can read or view the data.

The result data collecting step, the data classifying step, the data analyzing step, and the result arranging step are similar to those in the method of providing intangible knowledge information, and thus a detailed description thereof will be omitted. However, the result data collecting step differs from that in the method of providing intangible knowledge information in that the reward for the reading of knowledge information and the save and use of points are added as new data. The result arranging step differs from that in the method of providing intangible knowledge information in that data for the saved or used points is transmitted to the server of the mobile communication service provider to update data.

In the invention, data and commands are transmitted and received between the servers and between the vending machines by wire and wireless communication, and received data, which is knowledge information that is not stored in each vending machine, is executed by streaming, thereby displaying a picture, audio, or a moving picture (which may not include audio). The executed data includes all of a picture file, an audio file, and a video file that will be displayed on the Internet (web). For example, the picture file has an extension, such as jpg, gif, bmp, eps, png, pict, tiff, or tga. The audio file has an extension, such as mp3, wma, ra, aif, au, vqf, ac3, or ogg. The video (moving picture) file has an extension, such as avi, mpg, wmv, divx, rm, mov, mp3, mov, or asf.

Although the method of managing a vending machine, the method of providing intangible knowledge information, and the method of acquiring knowledge information have been described above, the invention is not limited thereto. Combinations of the methods may be made.

### ADVANTAGEOUS EFFECTS

As described above, according to the invention, it is possible to check articles and knowledge information that are frequently used in real time and immediately apply the check result to the vending machines. Therefore, tangible or intangible rewards for the purchase of products and the reading or viewing of knowledge information can be used to acquire knowledge information, which makes it possible to contribute to activating the use of knowledge information. In addition, since it is possible to check the actual number of persons who view knowledge information displayed, it is possible to obtain the result data close to the actual data. Further, an information acquirer can acquire desired information. That is, the information acquirer can acquire knowledge information in various methods by viewing desired information displayed on a monitor of the vending machine and printing out the information, or transmitting the information to his or her mobile communication apparatus. Furthermore, since the management of vending machines and the display and output of knowledge information are performed by one main server and a plurality of local servers, it is possible to disperse traffic and thus reduce a server load. As a result, it is possible to smoothly provide articles and knowledge information and effectively manage vending machines.

### DESCRIPTION OF DRAWINGS

FIG. 1 is a diagram illustrating the structure of a system according to the invention.

FIG. 2 is a diagram illustrating the outward appearance of a vending machine according to the invention.

FIG. 3 is a control block diagram illustrating the vending machine shown in

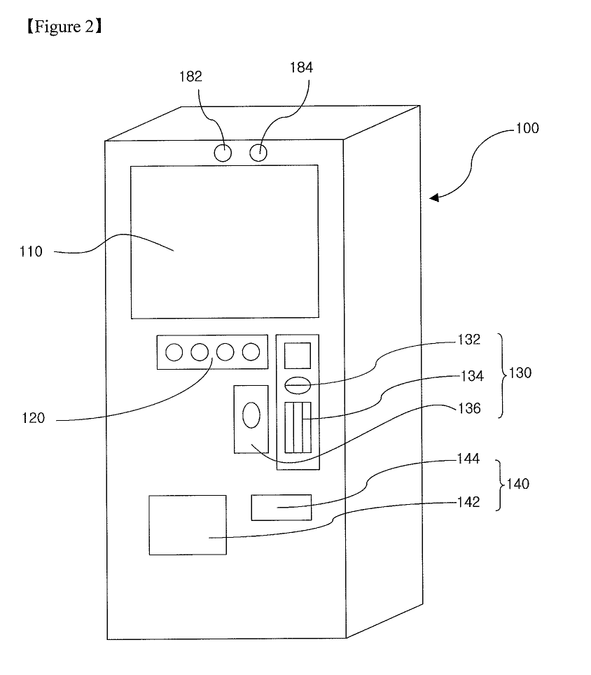

FIG. 2.

FIG. 4 is a flowchart illustrating a method of managing a vending machine according to the invention.

FIG. 5 is a flowchart illustrating a method of providing intangible knowledge information according to the invention.

FIG. 6 is a flowchart illustrating a method of acquiring intangible knowledge information.

### REFERENCE NUMERALS

100: Vending machine
110: Display device
120: Selection input unit
130: Payment unit
140: Discharge unit
150: External communication unit
160: Memory
170: Controller (CPU)
182: Human detection sensor
184: Image recognizing unit
200: Local server
300: Main server
400: Wire and wireless communication network
500: Mobile communication apparatus
600: External server
700: Mobile communication service provider server

### BEST MODE

Hereinafter, exemplary embodiments of the invention will be described in detail with reference to the accompanying drawings.

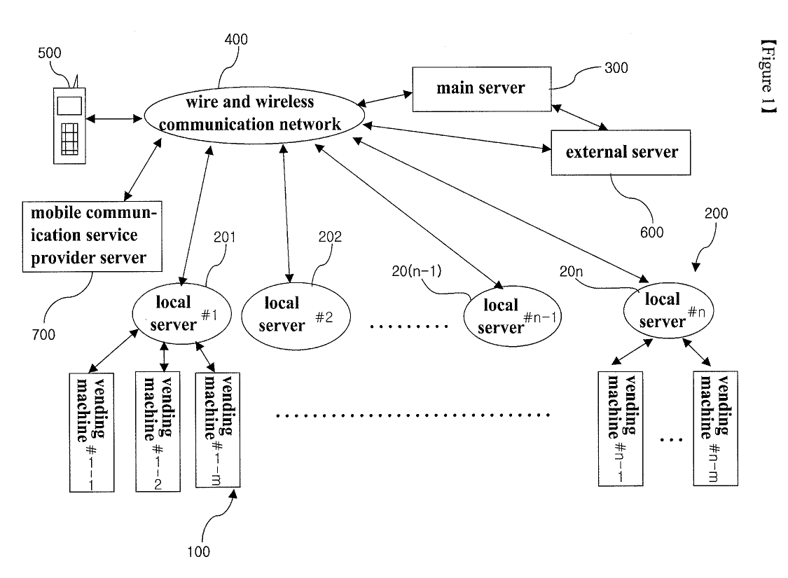

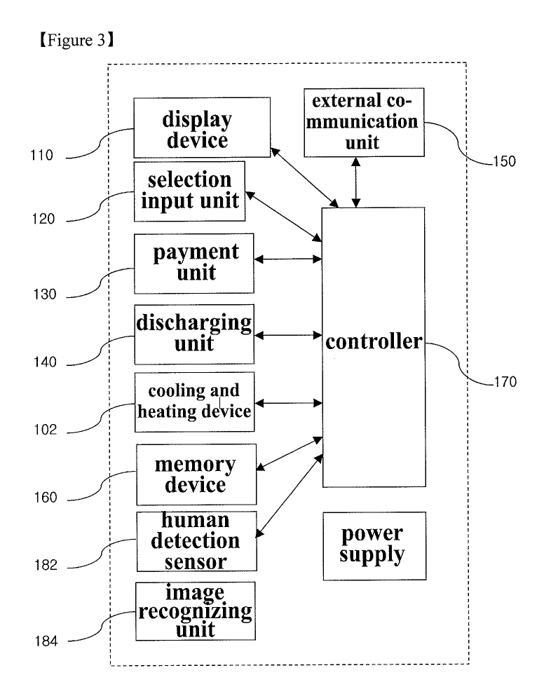

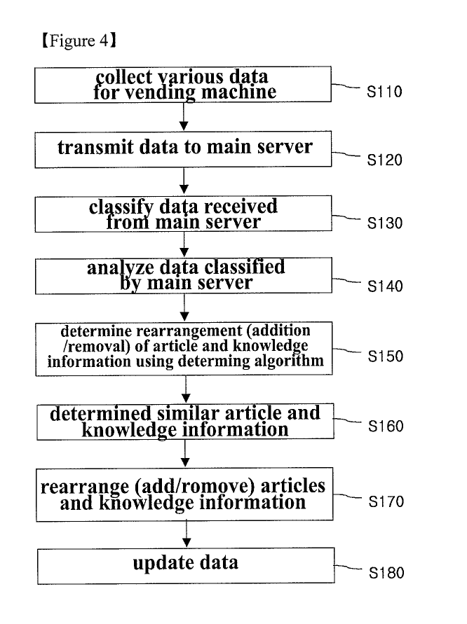

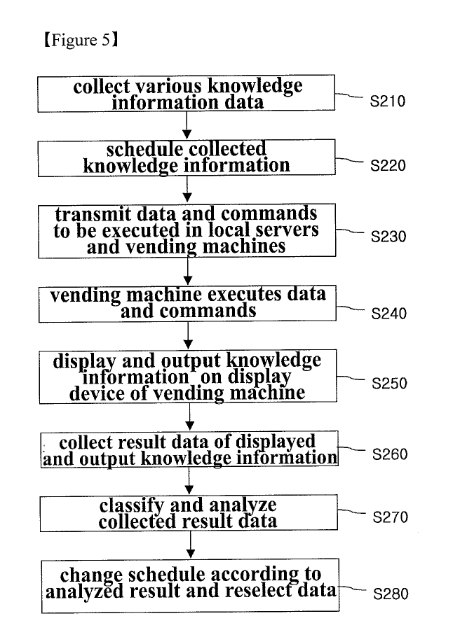

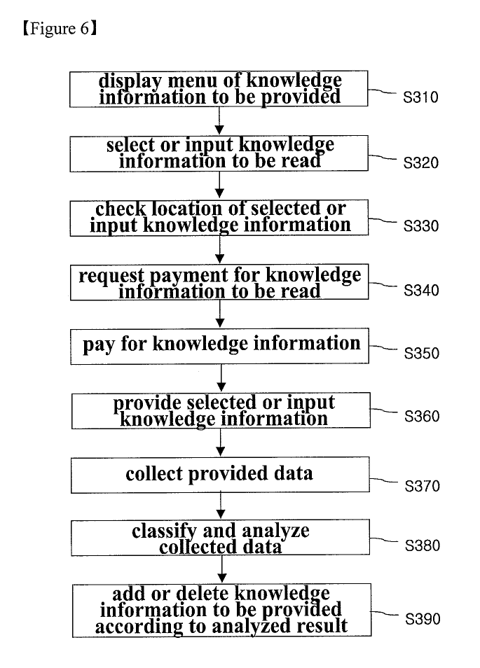

FIG. 1 is a diagram illustrating the structure of a system according to the invention. FIG. 2 is a diagram illustrating the outward appearance of a vending machine according to the invention. FIG. 3 is a control block diagram illustrating the vending machine shown in FIG. 2. FIG. 4 is a flowchart illustrating a method of managing the vending machine according to the invention. FIG. 5 is a flowchart illustrating a method of providing intangible knowledge information according to the invention. FIG. 6 is a flowchart illustrating a method of acquiring intangible knowledge information according to the invention.

The system according to the invention shown in FIG. 1 includes: a plurality of vending machines 100 that provide articles or knowledge information; a plurality of local servers 200 that group the vending machines and manage the groups of the vending machines; a main server 300 that controls the local servers; a wire and wireless communication network 400 that connects the vending machines, the local servers, and the main server; a mobile communication apparatus 500 that can transmit voice or data by wire or wirelessly; an external server 600 that provides external specific knowledge information, not data of the system; and a mobile communication service provider server 700 that controls the mobile communication apparatus 500.

As shown in FIGS. 2 and 3, the vending machine 100 according to the invention has a general structure that is provided with a power supply, has articles loaded therein, and can discharge the articles to the outside. The vending machine 100 includes: a cooling and heating device 102 that cools or heats the articles loaded therein; a display device 110 that visually displays knowledge information or outputs it as a sound, and has an input unit, such as a touch screen, provided therein or an external input device added thereto; a selection input unit 120 that selects articles or knowledge information; a payment unit 130 that includes a slot 132 into which a coin or paper money for articles is inserted, a reader 134 that can read magnetic cards or IC cards, and an optical recognition unit that enables payment using the mobile communication apparatus 500 or a mobile communication payment unit 136 that communicates with the external communication unit 150 to perform a payment process for the articles; a discharge unit 140 that discharges articles or printed outputs corresponding to knowledge information and includes an outlet 142 for articles or a discharger 144 that discharges knowledge information as an article; an external communication unit 150 that is connected to the wire and wireless communication network; a memory device 160 storing instructions, signal, and data that are input to or output from all the components of the vending machine 100 or the outside; a human detection sensor 182 that includes an optical sensor using an infrared ray or a laser beam, and a radio wave sensor and can count the number of persons passing by the vending machine 100; an image recognizing unit 184 that can count the number of persons gathered in front of the vending machine 100 for a predetermined time; and a controller (CPU) 170 that controls all the components of the vending machine 100.

In the embodiment of the invention having the above-mentioned structure, Apache Webservers are used as the main server 300 and the local servers 200, Oracle databases are used as a database (DB) and a database management system (DBMS), general devices are used as a hard disk, a ROM, a RAM, and an I/O interface, and a PDA (personal digital assistant) that is provided with a camera and can transmit/receive data using RF signals is used as the mobile communication apparatus 500. In addition, a touch screen TFT LCD monitor is used as the display device 110 of the vending machine 100, an electrical type button is used as the selection input unit 120, a general bill validator that can identify coins or paper money is used as the slot 132, an RF reader is used as the reader 134, an RF reader is used as the mobile communication payment unit 136, a general laser printer is used as a discharger 144 that discharges knowledge information as an article, a radio wave sensor is used as the human detection sensor 182, and a camera and a moving image processing technique are used as the image recognizing unit 184.

A method of managing a vending machine using the above-mentioned system includes: a data collecting step of allowing each local server 200 to collect data stored in the memories 160 of the vending machines 100 that are managed by the local server 200, the data including data for the positions of the vending machines, article information data, such as the kind and number of articles loaded in or discharged from the vending machines, and date and time when the articles are loaded in or discharged from the vending machines, and knowledge information data, such as the kind of knowledge information items stored in or output from the vending machine, the number of hits of the knowledge information, and date and time when the knowledge information items are stored in or output from the vending machines (S110); a data transmitting step of allowing the local server 200 to transmit the collected data to the main server 300 (S120); a data classifying step of allowing the main server 300 to classify the received data according to area, kind, data, time, the number of articles, and the number of hits of knowledge information (S130); a data analyzing step of allowing the main server 300 to use the classified data to analyze the utilization, the frequency of use, a variation in the frequency of use, and the moving average of the utilization of each kind of articles or knowledge information; the preference of each kind of articles, a variation in the preference, and the moving average of the preference in each vending machine; and the utilization, the frequency of use, a variation in the utilization, and the moving average of the utilization of each kind of articles in each vending machine, using math FIGS. 1 to 9 (S140); a rearrangement determining step of allowing the main server 300 to determine articles or knowledge information to be added or removed, that is, articles or knowledge information to be rearranged, using the center of gravity, a determining algorithm that uses a fuzzy function as a determining function, and math FIGS. 12 to 16 (S150); a similar article and knowledge information determining step of allowing the main server 300 to determine articles and knowledge information to be added and similar articles and knowledge information, using an index table and similarity represented by math figure 17 (S160); a rearrangement executing step of allowing the main server 300 to add or delete data that the main server 300 will execute, among the data to be added or deleted and to transmit data including rearrangement commands to each of the local servers 200, and allowing each of the local servers 200 having received the rearrangement commands to add or remove articles or knowledge information according to the instructions from the main server 300 (S170); and a data updating step of allowing the main server 300 and the local servers 200 to update data on the basis of the executed data (S180).

In addition, the rearrangement determining step (S150), the similar article and knowledge information determining step (S160), and the rearranging step (S170) including the rearrangement of data and the transmission of the rearrangement commands by the main server may further include a vending machine adding or removing step of adding or removing vending machines in a specific area.

Next, a method of providing intangible knowledge information will be described.

The method includes: a basic data collecting step of allowing the main server 300 to collect knowledge information data scheduled to be executed, such as commercial or public service ads, weather information, product information, and official announcement of a village or a local community in which the vending machines are installed, among intangible knowledge information items stored in the memories of the main server 300, the external server 600, each local server 200, and each vending machine 100 (S210); a scheduling step of allowing the main server 300 to schedule the basic data and to allocate the kinds of data to be executed by each vending machine 100, the time when the vending machine 100 executes the basic data, and the number of times the vending machine 100 executes the basic data, according to the schedule (S220); a first data or command transmitting step of allowing the main server 300 to transmit, to each local server 200, data for knowledge information that is allocated to each of the vending machines 100 according to the schedule such that it is displayed on the display device 110 of each of the vending machines 100, among the data stored in the main sever, allowing the main server 300 to transmit, to each local server 200, commands to transmit data stored in the local server 200 to each vending machine 100, or allowing the main server 300 to transmit, to each local server 200, commands to execute data stored in each vending machine 100, and a second command and data transmitting step of allowing each local server 200 having received the data and commands to transmit, to the vending machines 100 that are managed by the local server 200, data received from the main server, data stored therein, or commands to execute data stored in the vending machines 100 (S230); a data or command executing step of allowing each vending machine 100 having received data or command in the second data and command transmitting step to execute the received data or perform the received command on knowledge information data stored therein to output a sound or display an image (S240); an information displaying step of allowing the display device 110 of each vending machine 100 to visually display the knowledge information or output it as a sound according to the received data or commands (S250); a traffic calculating step of allowing each vending machine 100 to count the number of persons passing by the vending machine according to time and date, using the human detection sensor 182, which is a radio wave sensor, that detects the human bodies (S252); a step of allowing each vending machine 100 to count the number of persons who view information displayed on the display device, using the image recognizing unit 184 utilizing a camera and a moving image processing technique (S254); a result data collecting step of allowing the main server 300 to collect the result data of the displayed information in real time or at predetermined time intervals (S260); a data analyzing step of allowing the main server 300 to classify the collected data, according to area, kind, date, time, the number of articles, and the number of hits, and allowing the main server 300 to analyze the classified data to find the most effective way to utilize the vending machines according to date and time, on the basis of data related to areas where the vending machines are positioned, data related the number of persons who pass by the vending machines, data related to the natural environment, and data related to a social environment (S270); and a result arranging step of allowing the main server 300 to change the schedule according to the analyzed data, reselect data to be executed among the basic data according the changed schedule, and arrange the data (S280).

After the last step, the process returns to the data or command executing step (S240) to provide knowledge information that is added or is not removed even when the schedule is changed.

Next, a method of acquiring intangible knowledge information will be described.

The method includes: a menu display step of displaying, on the display device 110, a menu (an icon-shaped menu or a menu capable of directly inputting text) of the knowledge information to be provided to the display device 110 including a TFT LCD monitor having a speaker and a touch screen added thereto (S310); a knowledge information selecting step of selecting or inputting required knowledge information from the menu using the touch screen of the display device 110 or an external input device, such as a mouse or a keyboard provided in the selection input unit 120 of the vending machine (S320); a location checking step of allowing the main server 300 to check the position of the selected or input knowledge information data in the memories of the main server 300, the external server 600, the local servers 200, and the vending machines 100 (S330); a payment request step of requesting payment for providing the checked knowledge information (S340); a payment step of paying for goods or knowledge information by at least one of the following methods of inserting cash, such as coins or paper money, into the slot 132, or a credit card or a bus card into the reader 134, of paying money to a user who reads or views knowledge information, for example, a user who views a specific ad or answers questionnaires, and of paying money for goods with points saved in the mobile communication apparatus 500 by generating RF signals by communication between the mobile communication service provider server 700 and the mobile communication apparatus and making the mobile communication payment unit 136 recognize the RF signals (S350); a knowledge information displaying/outputting step of displaying or outputting knowledge information by at least one of a method of displaying the knowledge information paid for by cash or the credit card on the monitor of the display device 110 of each vending machine 100 or outputting it as a sound, a method of providing the knowledge information as a print out by discharging the print out through the discharger 144, and a method of transmitting the knowledge information to the mobile communication apparatus 500 of a person who acquires the knowledge information such that the knowledge information is displayed on the mobile communication apparatus 500 (S360); a result data collecting step of allowing the main server 300 to collect the result data of the displayed knowledge information and data for the paid point in real time and at a predetermined time interval (S370); a data classifying step of allowing the main server 300 to classify the collected result data according to area, kind, date, time, the number of articles, and the number of hits, and of allowing the main server 300 to analyze the number of hits of each knowledge information, the type of payment for goods, and the output type of knowledge information, on the basis of the classified data, and to analyze knowledge information to be added or deleted (S380); and a result arranging step of allowing the main server 300 to determine knowledge information data to be added or deleted on the basis of the classified data, and reflect the knowledge information (S390). After the last step, the process returns to the menu display step (S310) to acquire knowledge information that is added or is not deleted in the result arranging step (S390).

Although an embodiment of the invention has been described above, it will be apparent to those skilled in the art that various modifications and changes may be made without departing from the scope and spirit of the present invention.

Therefore, it should be understood that the above embodiments are not limitative, but illustrative in all aspects. The scope of the present invention is defined by the appended claims rather than by the description preceding them, and therefore all changes and modifications that fall within metes and bounds of the claims, or equivalents of such metes and bounds are therefore intended to be embraced by the claims.

1. A system of management, information providing and information acquisition for vending machine based upon wire and wireless communication, the system comprising:
a plurality of vending machines that provide articles or knowledge information;
a plurality of local servers that group the vending machines and manage the groups of the vending machines;
a main server that controls the local servers;
a mobile communication apparatus that can transmit or receive voice or data by wire or wirelessly; and
a wire and wireless communication network that connects the vending machines, the local servers, the main server and the mobile communication apparatus.

2. The system of claim 1,
wherein each of the vending machines includes:
a display device that visually displays the knowledge information or outputs it as a sound, and has an input unit, such as a touch screen, provided therein or an external input device added thereto;
a selection input unit that selects the articles or the knowledge information;
a payment unit that includes a slot into which a coin or paper money for articles is inserted, a reader that can read magnetic cards or IC cards, and an optical recognition unit that enables payment using the mobile communication apparatus or a mobile communication payment unit that communicates with an external communication unit to perform a payment process;
a discharge unit that discharges the articles or a print out of the knowledge information;
an external communication unit that is connected to the wire and wireless communication network;
a memory device storing instructions, signals, and data that are input to or output from all the components of the vending machine or the outside; and
a controller (CPU) that controls all the components of the vending machine.

3. The system of claim 2,
wherein the payment unit includes:
a slot into which a coin or paper money for articles is inserted;
a reader that can read magnetic cards or IC cards; and
an optical recognition unit that enables payment using the mobile communication apparatus or a mobile communication payment unit that communicates with the external communication unit to perform a payment process.

4. The system of claim 2,
wherein the vending machine further includes:
a human detection sensor that includes an optical sensor using an infrared ray or a laser beam, or a radio wave sensor, and can count the number of persons passing by the vending machine; and
an image recognizing unit that can count the number of persons gathered in front of the vending machine for a predetermined time.

5. The system of claim 3,
wherein the vending machine further includes:
a human detection sensor that includes an optical sensor using an infrared ray or a laser beam, or a radio wave sensor, and can count the number of persons passing by the vending machine; and
an image recognizing unit that can count the number of persons gathered in front of the vending machine for a predetermined time.

6. The system of claim 1,
wherein RFID tags, bar codes, color codes, or printed matters having numbers printed thereon that can be recognized by the mobile communication apparatus are attached to the articles used in the vending machine.

7. The system of claim 2,
wherein RFID tags, bar codes, color codes, or printed matters having numbers printed thereon that can be recognized by the mobile communication apparatus are attached to the articles used in the vending machine.

8. The system of claim 3,
wherein RFID tags, bar codes, color codes, or printed matters having numbers printed thereon that can be recognized by the mobile communication apparatus are attached to the articles used in the vending machine.

9. The system of claim 4,
wherein RFID tags, bar codes, color codes, or printed matters having numbers printed thereon that can be recognized by the mobile communication apparatus are attached to the articles used in the vending machine.

10. The system of claim 5,
wherein RFID tags, bar codes, color codes, or printed matters having numbers printed thereon that can be recognized by the mobile communication apparatus are attached to the articles used in the vending machine.

11. A method of managing a vending machine using the system of claim 1, the method comprising:
a data collecting step of allowing each local server to collect data stored in the memories of the vending machines that are managed by the local server, the data including data for the positions of the vending machines, article information data, such as the kind and number of articles loaded in or discharged from the vending machines, and date and time when the articles are loaded in or discharged from the vending machines, and knowledge information data, such as the kind of knowledge information items stored in or output from the vending machines, the number of hits of the knowledge information, and date and time when the knowledge information items are stored in or output from the vending machines;
a data transmitting step of allowing the local server to transmit the collected data to the main server;
a data classifying step of allowing the main server to classify the received data according to area, kind, date, time, the number of articles, and the number of hits of knowledge information;
a data analyzing step of allowing the main server to analyze the classified data;
a rearrangement determining step of allowing the main server to determine articles and knowledge information to be added or removed, that is, articles and knowledge information to be rearranged, on the basis of the analyzed data, using a determining algorithm;
a similar article and knowledge information determining step of allowing the main server to determine articles and knowledge information to be added and similar articles and knowledge information, using an index table;
a rearrangement executing step of allowing the main server to add or delete data that the main server will execute, among the data to be added or deleted, and a rearrangement data transmitting step of allowing the main server to transmit data including rearrangement commands to each of the local servers;
a rearranging step of allowing each of the local servers having received the rearrangement data to add or remove articles or knowledge information according to the commands from the main server; and
a data updating step of allowing the main server and the local servers to update data on the basis of the executed data.

12. The method of claim 11,
wherein, in the data analyzing step,
the utilization of each kind of article is calculated by math figure given below:
“the utilization of Pi(%)={the number of uses of Pi÷Σ(the number of uses of Pn)}×100”,
the frequency of use of each kind of article is calculated by math figure given below:
“the frequency of use of Pi(%)=(the number of uses of Pi at Tn÷the total number of uses of Pi until Tn)×100”,
a variation in the utilization of each kind of article is calculated by math figure given below:
“variation in the utilization of Pi(%)={(the number of uses of Pi today−the number of uses of Pi on the previous day)÷the total number of uses of Pi per unit time}×100”,
the moving average of the utilization of each kind of article is calculated by math figure given below:
“the moving average of the utilization of Pi(%)={(the number of uses of Pi from N o′clock to M o′clock)−(Tn+m−Tn)}×100”,
the preference of each kind of article in each vending machine is calculated by math figure given below:
“the preference of P(%)=[(the number of uses of Pn)÷{Σ(the number of uses of Pn)+Σ(the number of uses of Rn)+Σ(the number of uses of Mn)+Σ(the number of uses of In)}]×100”,
a variation in the preference of each kind of article in each vending machine is calculated by math figure given below:
“variation in the preference of P(%)={(the preference of P today−?the preference of P on the previous day)÷the total number of uses of P per unit time}×100”,
the moving average of the preference of each kind of article in each vending machine is calculated by math figure given below:
“the moving average of the preference of P(%)={(the preference of P from N o′clock to M o′clock)÷(Tn+m−Tn)}×100”,
the utilization of each vending machine is calculated by math figure given below:
“the utilization of a vending machine ‘a’(%)=(the number of persons using the vending machine ‘a’ per day÷the average number of persons using the vending machines belonging to a group ‘A’)×100”,
the frequency of use of each vending machine is calculated by math figure given below:
“the frequency of use of the vending machine ‘a’(%)=(the number of persons using the vending machine ‘a’ at Tn÷the total number of persons using the vending machine ‘a’ until Tn)×100”,
a variation in the utilization of each vending machine is calculated by math figure given below:
“variation in the utilization of the vending machine ‘a’={(the number of persons using the vending machine ‘a’ on a specific day−the number of persons using the vending machine ‘a’ the day before)÷the total number of persons using the vending machine ‘a’ per unit time}×100”, and
the moving average of the utilization of each vending machine is calculated by math figure given below:
“the moving average of the utilization of the vending machine ‘a’(%)={(the number of persons using the vending machine ‘a’ from N o′clock to M o′clock)÷(Tn+m−Tn)}×100”.

13. The method of claim 11,
wherein, in the rearrangement determining step,
a determining algorithm using a fuzzy function as a determining function is used,
a triangle variable used in a membership function is represented by math figure given below:
A(x)=1/{a(|x_{-b}|+a)}, a>0
a fuzzy rule is defined by math figure given below:
If x₁ is Aᵢ₁, x₂ is Aᵢ₂, x₃ is Aᵢ₃ then y is Bᵢ
a fuzzy rule number is calculated by math figure given below:
R=Uᵢ₌₁ⁿXRᵢ
an output function is obtained by math figure given below:
B^{o}=Uᵢ₌₁ⁿBᵢ^{x}
Bᵢ^{x} is calculated by math figure given below:
Bᵢ^{x}(y)=wᵢ [symbol] Bᵢ(y), and
the results of math figures are calculated by the center of gravity.

14. The method of claim 12,
wherein, in the rearrangement determining step, a determining algorithm using a fuzzy function as a determining function is used,
a triangle variable used in a membership function is represented by math figure given below:
A(x)=1/{a(|x_{-b}|+a)}, a>0
a fuzzy rule is defined by math figure given below:
If x₁ is Aᵢ₁, x₂ is Aᵢ₂, x₃ is Aᵢ₃ then y is Bᵢ
a fuzzy rule number is calculated by math figure given below:
R=Uᵢ₌₁ⁿXRᵢ
an output function is obtained by math figure given below:
B^{o}=Uᵢ₌₁ⁿBᵢ^{x}
Bᵢ^{x} is calculated by math figure given below:
Bᵢ^{x}(y)=wᵢ [symbol] Bᵢ(y), and
the results of math figures are calculated by the center of gravity.

15. The method of claim 11,
wherein, in the similar article and knowledge information determining step, the similarity is calculated by math figure given below:
$${C}_{a - b} = \sqrt{\begin{matrix}{( {x}_{a 1} - {x}_{b 1} )}^{2} + {( {x}_{a 2} - {x}_{b 2} )}^{2} + \\ {( {x}_{a 3} - {x}_{b 3} )}^{2} + … + {( {x}_{an } - {x}_{bn} )}^{2}\end{matrix}}$$

16. A method of providing intangible knowledge information using the system of claim 1, the method comprising:
a basic data collecting step of allowing the main server to collect data for knowledge information that is scheduled to be executed and intangible knowledge information stored in the memories of the main server, the external server, each local server, and each vending machine;
a scheduling step of allowing the main server to schedule the basic data and to allocate the kind of data to be executed by each vending machine, the time when the vending machine executes the basic data, and the number of times the vending machine executes the basic data, according to the schedule;
a first data or command transmitting step of allowing the main server to transmit, to each local server, data for knowledge information that is allocated to each of the vending machines according to the schedule such that it is displayed on the display device of each of the vending machines, among the data stored in the main sever, allowing the main server to transmit, to each local server, commands to transmit data stored in the local server to each vending machine, or allowing the main server to transmit, to each local server, commands to execute data stored in each vending machine;
a second command and data transmitting step of allowing each local server having received the data and commands to transmit, to the vending machines that are managed by the local server, data received from the main server, data stored therein, or commands to execute data stored in the vending machines;
a data or command executing step of allowing each vending machine having received data or command in the second data and command transmitting step to execute the received data or perform the received command on knowledge information data stored therein to output a sound or display an image;
an information displaying/outputting step of allowing the display device of each vending machine to visually display the knowledge information or output it as a sound according to the received data or commands;
a result data collecting step of allowing the main server to collect the result data of the displayed information in real time or at predetermined time intervals;
a data classifying step of allowing the main server to classify the collected result data, according to area, kind, date, time, the number of articles, and the number of hits;
a data analyzing step of allowing the main server to analyze the classified data; and
a result arranging step of allowing the main server to change the schedule according to the analyzed data, reselect data to be executed among the basic data according the changed schedule, and arrange the data.

17. The method of claim 16, further comprising:
after the information displaying/outputting step,
a traffic calculating step of allowing each vending machine to count the number of persons passing by the vending machine, using the human detection sensor; and
an information recognition state checking step of allowing each vending machine to count the number of persons who view information displayed, using an image recognizing unit thereof.

18. The method of claim 16,
wherein, in the data analyzing step,
the data includes data related to areas where the vending machines are positioned, data related the number of persons who pass by the vending machines, data related to the natural environment, and data related to a social environment, and
the main server analyzes the classified data to find the most effective way to utilize the vending machines according to date and time, on the basis of the data.

19. A method of acquiring intangible knowledge information using the system of claim 1, the method comprising:
a menu display step of displaying a menu of the knowledge information to be provided to a display device provided in each vending machine;
a knowledge information selecting step of selecting or inputting required knowledge information from the menu using a touch screen of the display device or an external input device, such as a mouse or a keyboard provided in the vending machine;
a location checking step of allowing the main server to check the position of the selected or input knowledge information data in the memories of the servers;
a payment request step of requesting payment for providing the checked knowledge information;
a payment step of paying for articles or knowledge information by selecting at least one of cash payment, the reading of knowledge information provided by the vending machine, and the use of points saved;
a knowledge information displaying/outputting step of displaying or outputting the knowledge information paid for by money by at least one of a method of displaying the knowledge information on the display device of each vending machine, a method of providing the knowledge information as a print out, and a method of transmitting the knowledge information to a mobile communication apparatus of a person who acquires the knowledge information;
a result data collecting step of allowing the main server to collect the result data of the displayed knowledge information and data for the paid point in real time and at a predetermined time interval;
a data classifying step of allowing the main server to classify the collected result data according to area, kind, date, time, the number of articles, and the number of hits;
a data analyzing step of allowing the main server to analyze the classified data; and
a result arranging step of allowing the main server to determine whether to add or delete knowledge information data on the basis of the analyzed data, and reflect the knowledge information.

20. The method of claim 19,
wherein, in the payment step,
cash, such as coins or paper money, is inserted into a slot, and a credit card or a bus card is inserted into a reader to pay for articles or knowledge information,
a user pays for articles by reading specific knowledge information or answering questionnaires provided by the vending machine, and
points saved in the mobile communication apparatus are used as a substitute for money, and the vending machine recognizes a mark displayed on a screen of the mobile communication apparatus or RF signals transmitted from the mobile communication apparatus to receive payment for articles or knowledge information.

21. The method of claim 19,
wherein the data analyzing step analyzes the number of hits of each knowledge information, the type of payment for articles, and the output type of knowledge information, on the basis of the data classified in the data classifying step, and determines knowledge information to be added or deleted.
